(19) United States
(12) Patent Application Publication
(10) Pub. No.: US 2009/0309855 A1
(43) Pub. Date: Dec. 17, 2009

(54) LED Matrix Driving Device

(76) Inventors: Jongmin Wang, Seongnam -city (KR); Geraldine A. Koehler, Temple, TX (US)

Correspondence Address: MATTHEW J. ESSERMAN, 1414 S Penn Sq Unit 20F, PHILADELPHIA, PA, 19102, US

(21) Appl. No.: 12/309,085

(22) PCT Filed: Jul. 3, 2007
(86) PCT No.: PCT/US2007/015401

§ 371 Date: Jan. 5, 2009

(30) Foreign Application Priority Data
Jul. 3, 2006 (KR) 1020060062018

(51) Int. Cl. G09G 5/00; G09G 3/32

(52) U.S. Cl. 345/204; 345/82

(57) ABSTRACT

An LED driving device and method that individually controls the brightness of each LED or LED block of multiple LED arrays is provided. The LED driving device utilizes a comparison of a data input signal with a reference signal using a comparator. The LED driving device may function as a backlight device (e.g. for a LCD display) or may function as a LED display.

### FIELD OF THE INVENTION

The present invention relates generally to the field of display systems, and, more specifically, to LED driving devices for digital light display systems.

### BACKGROUND OF THE INVENTION

The technology that the present invention belongs to is concerned with an LED driving method that individually controls the brightness of each LED or LED block that is in row(s) and column(s) or randomly arrayed in multiple LED arrays and the LED driving device that implements it. As for the existing technology of the field, there are the independent driving method (FIG. 1) that independently control each LED or LED block and the scanned driving method (FIG. 2) that controls the LEDs of each row or LED block by scanning.

In the independent driving method (FIG. 1) that is an existing LED driving method, for each LED (1), there is one exclusive driver (2) and one exclusive data signal line (3), connected so that each LED is driven independently. In the figure, there are a total of 9 LEDs that are driven independently. The LED (1) shown in FIG. 1 can be one LED, or an LED block that has several arrayed LEDs connected. Driver (2) shown in FIG. 1 is a device used for the purpose of supplying electric current to LED (1) according to the data signal (3) input. The data signal (3) shown in FIG. 1 is a signal that contains information about how much electric current will be supplied to the LED (1). For such independent driving method, to drive n×n LEDs, n×n LED distributing wires are needed. Therefore, there is a problem that as the number of LEDs increases, the number of LED distributing wires increase exponentially in a ratio of n². For example, in order to drive 100×100 LED arrays, 10,000 distributing wires are needed. In addition, to implement independent driving, n×n data lines are also needed. That means in order to drive 100×100 LED arrays, 10,000 data lines are needed, and to support this need, an enormous number of logic IC will be needed.

In the scanned driving method (FIG. 2) that is an existing LED driving method, for each row of LEDs (4) and each column of LEDs (4), one driver (13) and one scanner switch (16) are connected respectively such that each LED is driven by the scanned driving method. Lines coming out of the one driver (13) are in bundle and are vertically connected to LEDs (4, 7, 10) while those lines coming out of the one scanner switch (16) are in a bundle and are horizontally connected to LEDs (4, 5, 6).

The scanned driving principle is described below. When t indicates the time required to complete a screen, during the time of 0˜t/3, the scanner switch (16) of the first row will be ON, and the scanner switches (17, 18) of the remaining rows will be OFF. At that time, data signals (19, 20, 21) that are appropriate to each LED (4, 5, 6) in the first row will enter into drivers (13, 14, 15), and each driver (13, 14, 15) supplies appropriate electric current to the LEDs (4, 5, 6) according to the data signals (19, 20, 21). Certainly, lines coming out of the driver (13) are also electronically connected to other LEDs (7, 10) in the column, but because the scanner switches (17, 18) are OFF, there is no electric current supplied to such LEDs (7, 10). Then the first scanner switch (16) becomes OFF, so LEDs (4, 5, 6) in the first row are turned off, and during the time of t/3˜2t/3, the second scanner switch (17) is ON, so the LEDs (7, 8, 9) of the second row will be turned on by the drivers (13, 14, 15) according to new data signals (19, 20, 21). Likewise, between the time of 2t/3˜t, the LEDs (4, 5, 6, 7, 8, 9) in both the first and second rows will be turned off, and the LEDs (10, 11, 12) in the third row will be turned on.

Since this kind of scanned driving method requires only 2n distributing wires and n data lines to drive n×n LED arrays, an extremely simple circuitry configuration is possible compared to the independent driving method, and this is an advantage of such a method. However, the disadvantage is that the brightness of the entire LED lighting drops to 1/n.

For example, when 100×100 LED arrays are driven, the brightness will decrease 100-fold compared to the independent driving method. That is, only 1% of the brightness that the LEDs can produce is produced.

The technological task that this invention wants to achieve is to introduce a switch circuitry that enables Pulse Width Modulation (PWM) to drive LED arrays as if driving TFT-LCD, so that the problems of wiring difficulty in the independent driving method and decrease of brightness in the scanned driving method can be solved at the same time.

These and other advantages of the present invention will become more fully apparent from the detailed description of the invention hereinbelow.

### SUMMARY OF THE INVENTION

The present invention is directed to an optical system for a display system, the optical system comprising a LED array comprising a plurality of LEDs. The optical system also comprises a LED driver electrically connected to each one of the plurality of LEDs. The optical system also comprises a reference signal generator that generates a reference signal. The optical system further comprises a PWM signal generating device comprising an input signal section. The PWM signal generating device also comprises a comparator that receives a data input signal from the input signal section as a first input, and receives a reference signal from the reference signal generator as a second input, wherein the comparator provides a comparison of the data input signal from the first input and the reference signal from the second input, wherein the comparator provides an output signal to one of the plurality of LEDs as a result of the comparison, and wherein the input signal section continuously provides the data input signal to the comparator only during a period starting from an ON signal input until a period when a RESET signal input is received within the input signal section via an elimination signal input.

### BRIEF DESCRIPTION OF THE DRAWINGS

For the present invention to be clearly understood and readily practiced, the present invention will be described in conjunction with the following figures, wherein:

FIG. 1 illustrates the configuration of an existing LED driving device (independent drive).

FIG. 2 illustrates the configuration of an existing LED driving device (scanned drive).

FIGS. 3(a) and 3(b) respectively illustrate a PWM driving device and LED driving device (matrix drive) that utilizes the PWM driving device, in accordance with a preferred embodiment of the present invention.

FIG. 4 illustrates a configuration of PWM switches of a LED driving device (matrix drive), in accordance with a preferred embodiment of the present invention.

FIG. 5 illustrates a driving method of an existing LED driving device (independent drive).

FIG. 6 illustrates a driving method of an existing LED driving device (scanned drive).

FIG. 7 illustrates a driving method of a LED driving device (matrix drive), in accordance with a preferred embodiment of the present invention.

FIG. 8 illustrates an example of a 2×2 array of a LED driving device, in accordance with a preferred embodiment of the present invention.

FIG. 9 illustrates an example of operating signals of a LED driving device, in accordance with a preferred embodiment of the present invention.

FIG. 10 shows a table of comparison of the present invention and existing technologies.

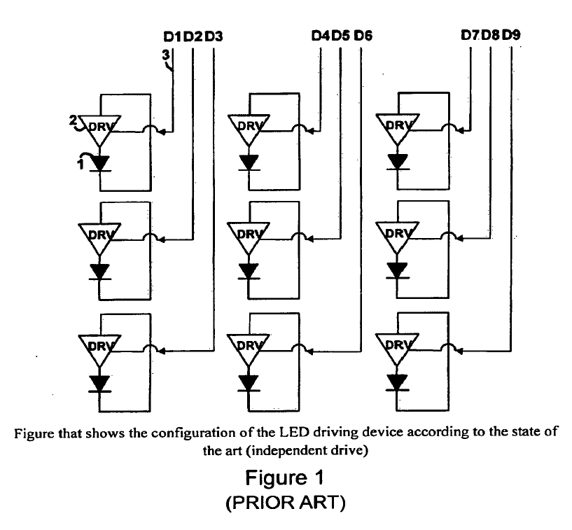

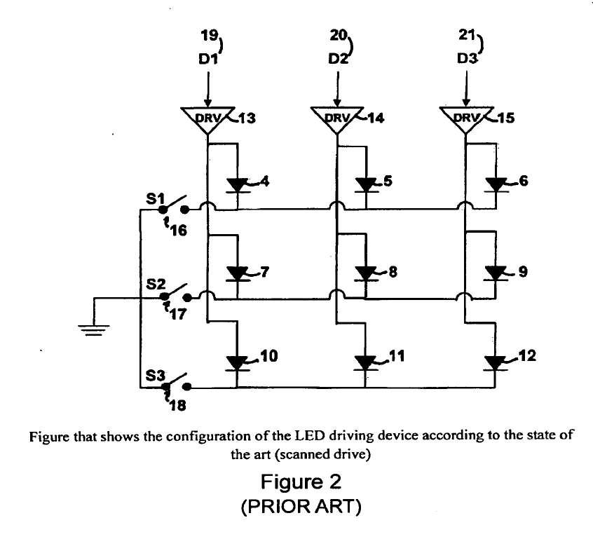

### DETAILED DESCRIPTION OF THE PREFERRED EMBODIMENTS

It is to be understood that the figures and descriptions of the present invention may have been simplified to illustrate elements that are relevant for a clear understanding of the present invention, while eliminating, for purposes of clarity, other elements found in a typical digital display system. Those of ordinary skill in the art will recognize that other elements may be desirable and/or required in order to implement the present invention. However, because such elements are well known in the art, and because they do not facilitate a better understanding of the present invention, a discussion of such elements is not provided herein. It is also to be understood that the drawings included herewith only provide diagrammatic representations of the presently preferred structures of the present invention and that structures falling within the scope of the present invention may include structures different than those shown in the drawings. Reference will now be made to the drawings wherein like structures are provided with like reference designations.

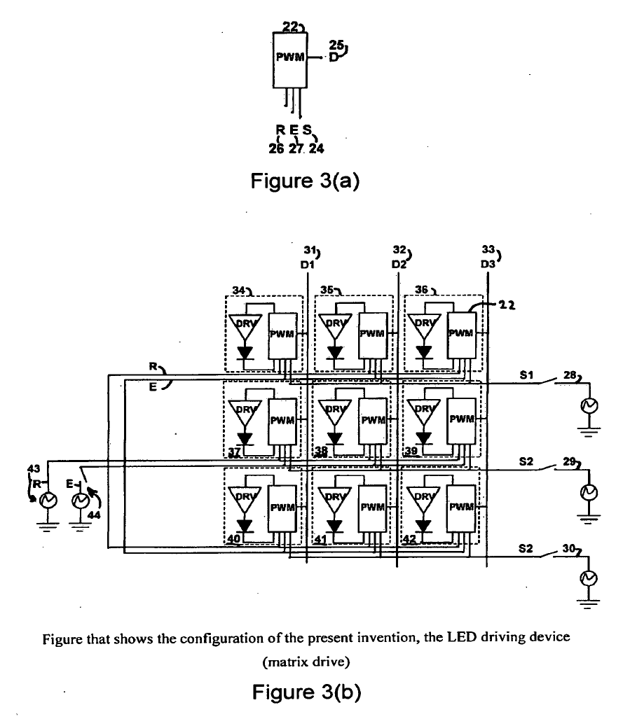

FIG. 3(a) shows the PWM switch (22) (or PWM signal generating device) of the present invention and input signals (24, 25, 26, 27) that are arriving to the PWM switch. The PWM switch (22) receives a voltage signal for LED brightness from the data signal input line (25), and it compares the voltage signal with a triangular wave (e.g. saw-tooth shaped) reference input signal (26) that is continuously arriving to the PWM switch (22), and once the triangular wave reference input signal (26) voltage is lower than the voltage coming from the data signal input line (25), it plays the role of a switch that allows electric current to flow to the LED. That is, since the time in which the switch is ON is determined depending on the size of data voltage arriving to the PWM switch (22), the LED brightness control by PWM is possible. Signals from the data signal input line (25) can only be received when the scan signal input line (24) is ON. After the scanning of the entire LED array is complete, that is, when one frame is complete, the elimination signal input line (27) turns ON so that data information that entered each LED array will be all deleted to await the signals for the next frame.

FIG. 3(b) shows an exemplary configuration of an entire LED matrix driving device that includes a plurality of PWM switches (22) as in FIG. 3(a). Each block (34, 35, 36, 37, 38, 39, 40, 41, 42) is configured to comprise a LED, a driver that supplies the electric current, and the PWM switch. Data input signal lines (25) of the PWMs in each block are electrically bundled in a vertical direction along with data lines (31, 32, 33), and the scan input signal lines (24) of the PWMs in each block are electrically bundled in a horizontal direction along with the scan lines/switches (28, 29, 30). The reference signal lines (26) of the PWMs in each block are attached to a triangular wave reference signal generator (43) as one while the elimination lines (27) of the PWMs in each block are attached to the elimination signal switch (44). The vertical and horizontal directions mentioned are exemplary. Other directions (e.g. preferably perpendicular from one another) may be employed.

The operating principle of the LED matrix driving device is described below. An LED array of 3×3 blocks is used as an example. First, when the scan line (28) of the first row becomes ON, a brightness voltage signal appropriate to each block (34, 35, 36) is transmitted to the PWM switches of each block along the data lines (31, 32, 33). Then, the scan line (28) of the first row becomes OFF, and the scan line (29) of the second row becomes ON. Although the scan line of the first row becomes OFF, the PWM switches of the first row keep storing the information they received from the data lines and compare the information with the signals that keep arriving from the triangular wave reference signal generator (43), and, based on this comparison, the PWM switches become ON and send electric current regardless of the fact that the scan line (28) is OFF. Like the blocks (34, 35, 36) in the first row, the blocks (37, 38, 39) of the second row also receive and store new data signals from data lines (31, 32, 33) when the scan line (29) of the second row is ON. Likewise, the scan switch (29) of the second row then turns OFF, and the scan switch (30) of the third row turns ON so that the PWM switches of the third row receive new data signals. When the scan switch (30) in charge of the third row also turns OFF, and the blocks (40, 41, 42) of the third row have completed displaying, the elimination switch (44) turns ON so that the voltage information saved in the PWMs of all lines disappear to prepare for the display of the next frame.

Matrix driving of such principle can configure much simpler circuitry than the independent driving method and at the same time the brightness is almost the same as that of the independent driving method. Particularly, in the case of wiring, it will become increasingly advantageous than the independent driving method as the number of blocks increases.

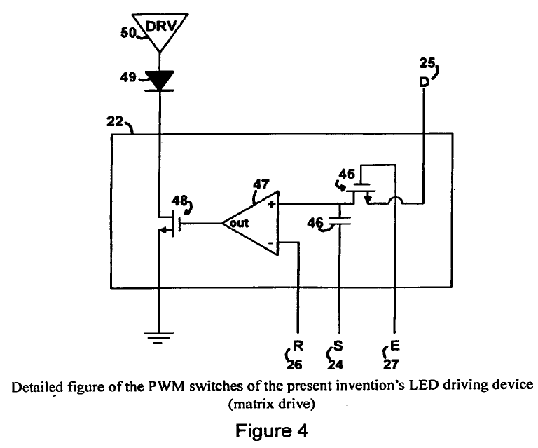

FIG. 4 shows a detailed preferred structure of the PWM switch (22) in the present invention's LED matrix driving device. The PWM switch (22) is composed of two semiconductor switches (45, 48), voltage storage device capacitor (46) and voltage comparator (47). First, the triangular wave reference voltage signal keeps arriving to the voltage comparator (47) through the triangular wave reference input signal line (26). The voltage comparator (47) is composed of three terminals: +terminal, −terminal, and output terminal. It compares the voltage coming into the + and − terminals, and when the voltage on the + side is stronger than that on the − side, it sends the voltage of predetermined strength to the output terminal. The voltage that is arriving from the data input signal line (25) charges the capacitor (46) when the scanner switch connected to the scanner line (24) is ON. When the scanner switch is OFF, the capacitor (46) that has been charged maintains appropriate voltage and saves voltage information that has come from the data input signal line (25). At this time, when the saw-tooth shaped voltage reference signal that is arriving from the triangular wave reference input signal line (26) is smaller than the voltage charged in the capacitor (46), the voltage comparator (47) sends voltage of predetermined magnitude to the output terminal. The semiconductor switch (48) receives the voltage, the semiconductor switch (48) turns ON, and a predetermined electric current from LED driver (50) flows into the LED (49). That is, the timing when electric current flows into the LED (49) is determined by the strength of the data signal that is coming in from the data input signal line (25). This is what enables the PWM of LED brightness. When the elimination switch is ON, the electrical connection to the elimination signal line (27) via semiconductor switch (45) is established, the electric charge that is charged in the capacitor (46) is fully released, so that the voltage data signal that the capacitor (46) contained disappears and the preparation for receiving the next data is complete.

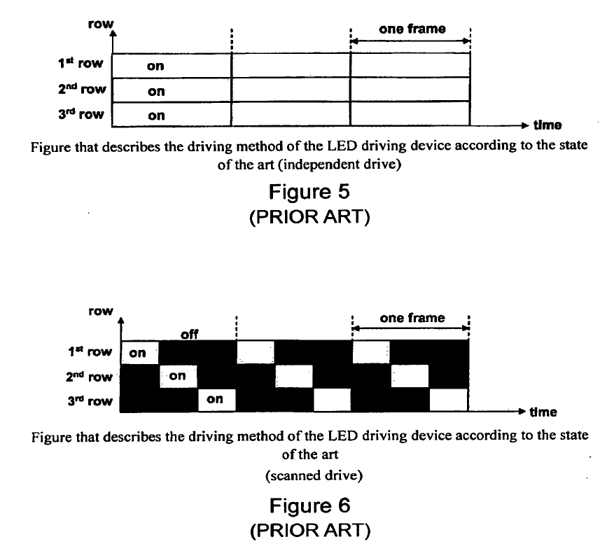

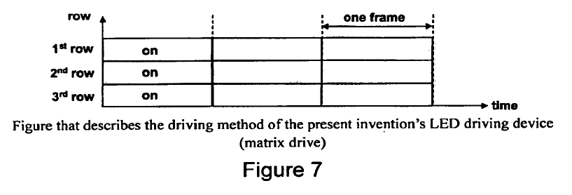

FIGS. 5, 6, and 7 describe the light loss when the LED array is used as a backlight of a LCD display. In the independent driving method described in FIG. 5, since all blocks shut down altogether, theoretically, there is no light loss due to the LED backlight. In the scanned driving method described in FIG. 6, because all other rows have to be OFF when one row is ON, in the case of a block array composed of n rows, the total light volume drops to 1/n compared to the independent driving method. In the matrix driving method of the present invention described in FIG. 7, there is slight light loss during the period of scanning, but when considering the extremely fast response speed of the LEDs, the light loss is almost or substantially zero (0).

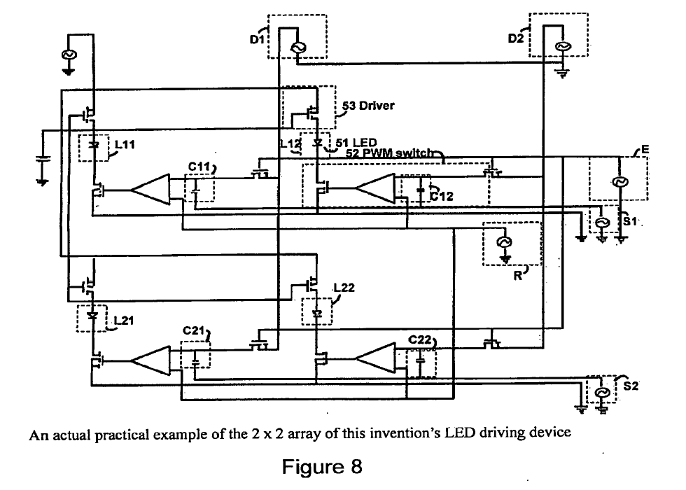

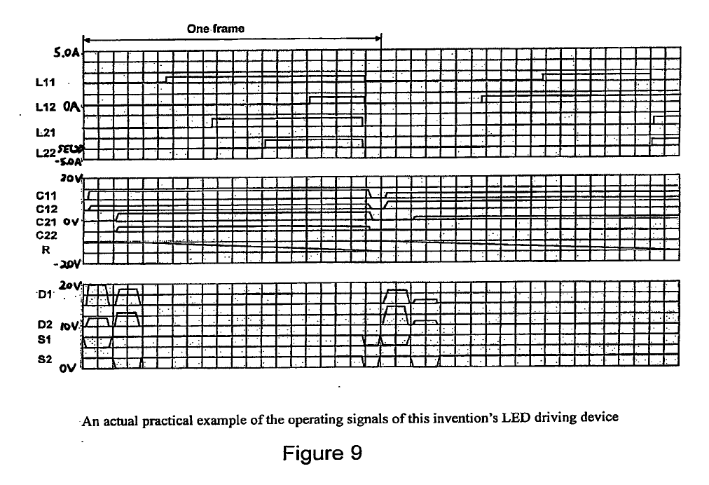

FIG. 8 shows an example of a 2×2 array of the present invention's LED matrix driving device. Each block is composed of an LED (51), driver (53) and PWM switch (52). The aforementioned capacitor (C11, C12, C21, C22) is inside each PWM switch, and each PWM switch is connected to a corresponding LED (L11, L12, L21, L22). Each PWM switch is combined vertically with data lines (D1, D2), and combined horizontally with scan switches (S1, S2), and all of these are electrically attached to one reference triangular wave generator (R) and elimination switch (E). In this example, the electric current supplied by the driver uses the current mirror method, but any driver other than that can also be used. FIG. 9 shows an example of the operating waveforms of the 2×2 LED matrix driving device described in FIG. 8. The vertical and horizontal directions mentioned are exemplary. Other directions (e.g. preferably perpendicular from one another) may be employed.

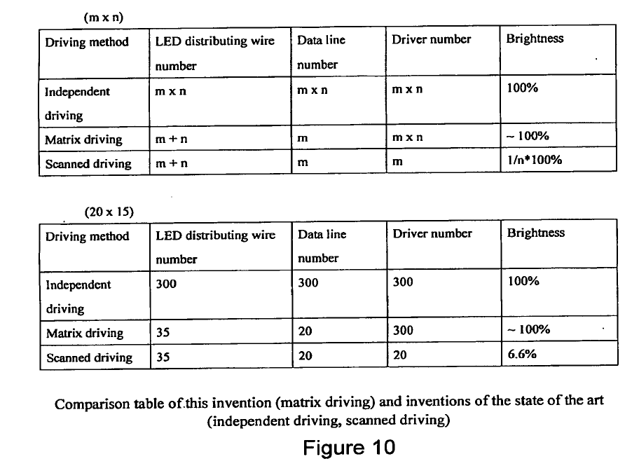

FIG. 10 is a table that compares the independent driving method and the scanned driving method of the state of the art with the present invention's matrix driving method. The matrix driving method of the present invention is a method that solves the problems of wiring difficulty in the independent driving method and decrease of brightness in the scanned driving method, and therefore enables the implementation of a LED driving device that is extremely bright and whose wiring is simple and efficient.

In particular, when the present invention is applied to a LCD TV, there are advantages as described below. Because line scanning is employed, the color blur due to the Field Sequential Color (FSC) of the LCD can be removed. Because PWM adjustment per line is employed, motion blur, which is a problematic point of the hold-type display, can be removed by applying a blinking drive. In addition, because it is possible to adjust the brightness of each block inside a line, regional dimming is also possible so that the contrast ratio may be increased drastically. The present invention's LED matrix driving device functions as described above, i.e. by using simple circuitry without significant brightness loss and improves the screen quality of the LCD TV.

Likewise, when the present invention is applied to LED electro-optic boards, any number (e.g. millions) of LEDs may be implemented by using simple circuitry without any significant light intensity loss.

In the exemplary embodiment described above, the comparator functions such that when the saw-tooth shaped voltage reference signal that is arriving from the triangular wave reference input signal line (26) is smaller than the voltage charged in the capacitor (46), the voltage comparator (47) sends voltage of predetermined magnitude to the output terminal. However, the comparator may alternatively be configured (e.g. by swapping input terminals) to send the voltage of predetermined magnitude to the output terminal when the saw-tooth shaped voltage reference signal that is arriving from the triangular wave reference input signal line (26) is larger than the voltage charged in the capacitor (46).

It is noted that the array of LEDs mentioned above may not be adjacent to one another. For example, they may in fact be provided in a random fashion. Also, the array may consist of a linear column or row of LEDs.

The present invention may be employed as a LED backlight unit (LED BLU) for any type of display, and is preferably employed as a LED BLU for LCD displays.

As an alternative to using the present invention as a backlight device for, e.g. LCD displays, the LED matrix driving device/LED matrix array may be employed as a LED image (or video) display itself. To accomplish this, the LEDs in the matrix would be selected for image display purposes rather than for backlighting purposes. The circuitry may be identical as described above for the BLU and would correspondingly be connected to a LED image driver instead of a LED backlight driver. The data signals in the data input signal line would of course contain image information as opposed to information for backlighting. These LEDs would be used as pixels for a thin, high contrast, LED display. Each triad may be a pixel, and may be individually addressed and/or dimmed. A LED image display of this type would benefit tremendously from the simple and efficient wiring scheme and extreme brightness similar to that exhibited by the LED BLU as explained above. The term “image” as mentioned in this disclosure is hereby defined to include “video” as well.

The contemplated modifications and variations specifically mentioned above are considered to be within the spirit and scope of the present invention.

Those of ordinary skill in the art will recognize that various modifications and variations may be made to the embodiments described above without departing from the spirit and scope of the present invention. For example, although the above embodiments of the present invention are described using a triangular wave (e.g. saw-tooth shaped) reference input signal (26), other types of reference input signals may alternatively be employed such as, for example, non-saw-tooth shaped triangular waves, sinusoidal waves, step shaped waves, etc. The reference signal generator (43) would correspondingly be modified to produce the desired reference input signal (26). For example, a sinusoidal wave generator may alternatively be employed to produce a sinusoidal wave reference input signal. It is therefore to be understood that the present invention is not limited to the particular embodiments disclosed above, but it is intended to cover such modifications and variations as defined by the following claims.

What is claimed is:

1. An optical system for a display system, the optical system comprising:
a LED array comprising a plurality of LEDs;
a LED driver electrically connected to each one of the plurality of LEDs;
a reference signal generator that generates a reference signal; and
a PWM signal generating device comprising:
an input signal section; and
a comparator that receives a data input signal from the input signal section as a first input, and receives a reference signal from the reference signal generator as a second input, wherein the comparator provides a comparison of the data input signal from the first input and the reference signal from the second input, wherein the comparator provides an output signal to one of the plurality of LEDs as a result of the comparison, and wherein the input signal section continuously provides the data input signal to the comparator only during a period starting from an ON signal input until a period when a RESET signal input is received within the input signal section via an elimination signal input.

2. The optical system of claim 1, wherein the input signal section continuously provides the data input signal to the comparator via a capacitor, and wherein the capacitor stores a value of the data input signal until discharging when the RESET signal input is received within the input signal section via the elimination signal input.

3. The optical system of claim 2, wherein the input signal section includes an elimination switch that charges the capacitor with the value of the data input signal during the ON signal input period, and discharges the capacitor during the RESET signal input period, whereby the data input signal provided as the first input to the comparator is reset.

4. The optical system of claim 1, further comprising a switch provided between the comparator and the one of the plurality of LEDs, wherein the switch receives the output signal from the comparator thereby turning the switch ON, and wherein the LED driver provides predetermined electric current to the LED only when the switch is ON.

5. The optical system of claim 1, wherein the comparator provides the output signal to one of the plurality of LEDs only when a value of the data input signal is larger than a value of the reference signal.

6. The optical system of claim 1, wherein the comparator provides the output signal to one of the plurality of LEDs only when a value of the data input signal is smaller than a value of the reference signal.

7. The optical system of claim 1, wherein each of the LEDs is an LED block containing a plurality of LEDs.

8. The optical system of claim 1, wherein the reference signal generator is a triangular wave reference signal generator, and the reference signal is a triangular wave reference signal.

9. The optical system of claim 1, wherein the LED array is provide in an M×N array, wherein N data lines that supply the same data input signal to M input signal sections in which each data line is connected along a first direction, and wherein M scan lines are connected to N input signal sections via a corresponding capacitor, in which each scan line is connected along a second direction perpendicular to the first direction and is sequentially turned ON and OFF thereby sequentially providing the ON signal input to the N input signal sections.

10. The optical system of claim 9, wherein the same reference signal is provided to each comparator.

11. The optical system of claim 9, wherein the same RESET signal input is provided to each input signal section.

12. The optical system of claim 1, wherein the data input signal contains backlight information such that the optical system functions as a backlight device.

13. The optical system of claim 12, wherein the display system is a LCD-type.

14. The optical system of claim 1, wherein the data input signal contains image information such that the optical system functions as an image device, and wherein the display system is a LED display.
